(19) United States
(12) Patent Application Publication
(10) Pub. No.: US 2009/0063506 A1
(43) Pub. Date: Mar. 5, 2009

(54) METHOD AND APPARATUS FOR GENERATING RECOMMENDATION CONTENT LIST

(75) Inventors: Sang-wook CHO, Suwon-si (KR); Cheol-Ju Hwang, Yongin-si (KR); Soo-hong Park, Gwangju-si (KR); Jae-hwang Lee, Seoul (KR); Min-ho Lee, Gwacheon-si (KR); Sung-hwan Choi, Seoul (KR); Jeong-rok Jang, Suwon-si (KR); Yun-ju Choe, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/107,865

(22) Filed: Apr. 23, 2008

(30) Foreign Application Priority Data
Aug. 31, 2007 (KR) 2007-88304

(51) Int. Cl. G06F 17/30

(52) U.S. Cl. 707/10; 707/E17.032

(57) ABSTRACT

A method and apparatus for generating a recommendation content list by the cooperation of user groups. Sets of content that are classified according to a predetermined criterion are distributed to user terminals within a user terminal group. Assessment information on the content included in the sets of content is collected from the corresponding user terminals, and the recommendation content list is then generated based on the collected assessment information.

### CROSS-REFERENCE TO RELATED APPLICATION

This application claims the benefit of Korean Application No. 2007-88304, filed in the Korean Intellectual Property Office on Aug. 31, 2007, the disclosure of which is incorporated herein by reference.

### BACKGROUND OF THE INVENTION

1. Field of the Invention

Aspects of the present invention relate to a method and apparatus for generating a recommendation content list, and more particularly, to a method and apparatus for generating a recommendation content list by the cooperation of user groups.

2. Description of the Related Art

The kinds and amount of content available to users, such as music, books, movies or the like, are steadily increasing. The explosive spread of the Internet has vastly increased the amount of content available to users. As the amount of content provided to users increases, it becomes more difficult for a user to accurately search for, and reproduce, desired content. In order to reduce the time required to search for the desired content, a system providing recommendation content has been introduced.

In a conventional recommendation content providing system, the ranks of content or items are assessed based on the scores of the content or items that are marked by other users, and a recommendation content list is generated. The user searches for and reproduces the content on the recommendation content list, thereby saving time otherwise required to search for desired content.

However, it is in fact impossible to obtain the assessment information on all content because the kinds and amount of provided content are excessive. In addition, the content appearing on the recommendation content list after having been assessed is limited. New content may be excluded from the ranking because there is no assessment information on the new content, and so the new content cannot be ranked high even though included in the ranking.

Content without assessment information cannot be included in the recommendation list. A list of content without assessment information needs to be provided to a user via an additional user interface, separated from the recommendation list, in order to induce users to make assessments.

However, although it is possible to obtain assessment information on such content without assessment information by providing the content to a user via a separate interface, it is impossible to provide a full list of the new content to the user for assessment because the amount of content is huge. In addition, an identical list of new content is provided to each user, so that some of the content is viewed and assessed by users, whereas other content may not be assessed by a user.

In the conventional recommendation content providing system, it takes a large amount of time to generate the assessment information for new content, and even an assessment on excellent content is not ensured, so that the content cannot be ranked on the recommendation list. Such a system is inefficient and unreasonable.

### SUMMARY OF THE INVENTION

Aspects of the present invention provide a method and apparatus for generating a recommendation content list in which content without assessment information or with insufficient assessment information is appropriately allocated to user terminals within a user terminal group and assessed, thereby achieving a rapid and reasonable assessment of the content.

According to an aspect of the present invention, a method of generating a recommendation content list that is shared by user terminals in a user terminal group is provided. The method comprises distributing sets of content that are classified according to a predetermined criterion to the user terminals within the user terminal group; collecting assessment information from the corresponding user terminals on the content included in the sets of content; and generating the recommendation content list based on the collected assessment information on the content.

According to another aspect of the present invention, the collecting of the assessment information comprises transferring address information of metadata for the content included in the sets of content to the corresponding user terminals; and receiving the assessment information on the content, which is obtained based on the metadata, from the corresponding user terminals.

According to another aspect of the present invention, the user terminal group is a set of user terminals with a similar preference in terms of content.

According to another aspect of the present invention, the sets of content that are classified according to the predetermined criterion are classified by content provider.

According to another aspect of the present invention, the distributing of the sets of content to the user terminals comprises generating identification numbers for the respective sets of content; and distributing the identification numbers to the respective user terminals within the user terminal group.

According to another aspect of the present invention, the identification numbers are hash values generated using a hash function.

According to another aspect of the present invention, the distributing of the identification numbers to the respective user terminals comprises performing a modular operation on each of the identification numbers; and distributing the identification numbers with the same modular operations results to a specific user terminal within the user terminal group, based on the results of the modular operations.

According to another aspect of the present invention, the method further comprises storing the recommendation content list.

According to another aspect of the present invention, an apparatus to generate a recommendation content list that is shared by user terminals within a user terminal group is provided. The apparatus comprises a content distribution manager to distribute sets of content that are classified according to a predetermined criterion to the user terminals within the user terminal group; an assessment information collection unit to collect assessment information on the content included in the sets of content from the corresponding user terminals; and a recommendation content list generation unit to generate the recommendation content list based on the collected assessment information on the content.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a recommendation content list generating apparatus according to an embodiment of the present invention;

FIG. 2 illustrates an embodiment of the identification number distribution unit shown in FIG. 1;

FIG. 3 illustrates an example of displaying a list of content to be assessed on a user terminal;

FIG. 4 illustrates a recommendation content list generating apparatus according to another embodiment of the present invention that is implemented in a similar user terminal group; and

FIG. 5 is a flowchart of a recommendation content list generating method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

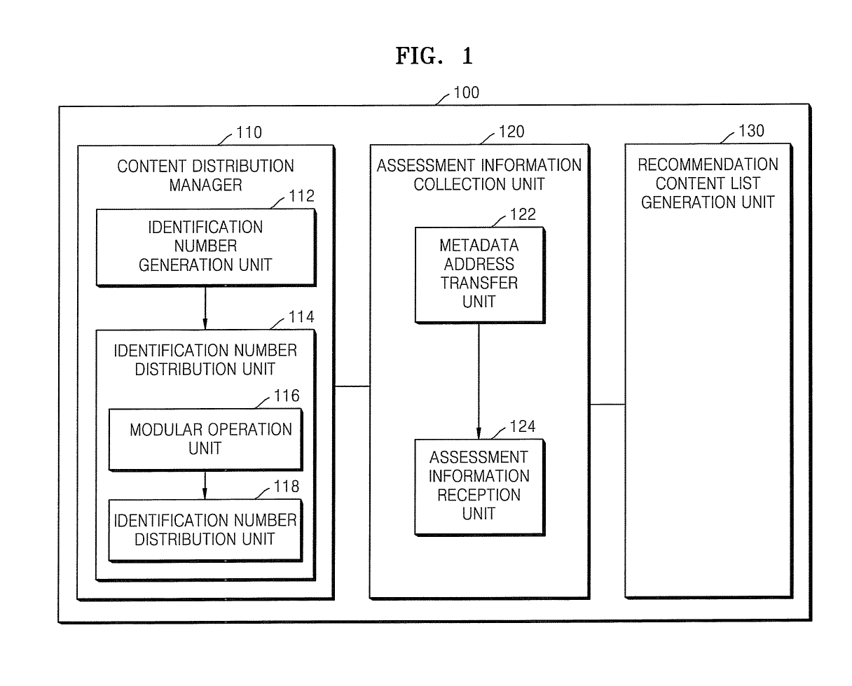

FIG. 1 is a block diagram of a recommendation content list generating apparatus 100 according to an embodiment of the present invention. The recommendation content list generating apparatus 100 generates a recommendation content list shared by user terminals in a user terminal group. The recommendation content list generating apparatus 100 includes a content distribution manager 110, an assessment information collection unit 120, and a recommendation content list generation unit 130. According to other aspects of the present invention, the recommendation content list generating apparatus 100 may include additional and/or different units. Similarly, the functionality of two or more of the above units may be integrated into a single component.

The content distribution manager 110 distributes sets of content that are classified according to a predetermined criterion to user terminals in a user terminal group. The criterion for classifying the sets of content varies, and may include the kind of content, the time of generating content, content providers, etc. In addition, when sets of content are classified by content providers, the sets of content may be further classified by web servers into different subgroups. Alternatively, although the content is provided via the same web server, the content may be classified by content distributors into different groups.

For example, content may be classified by content providers. In particular, content from No. 1 to No. 7 are provided on a website named ‘daum’, content from No. 8 to No. 11 are provided on a website named ‘naver’, and content from No. 12 to No. 15 are provided on the website named ‘daum’. In this case, the content can be classified into two groups based on the content provider. A first set of content includes the content from No. 1 to No. 7 and the content from No. 12 to No. 15, which are provided on the website ‘daum’. A second set of content includes the content from No. 8 to No. 11 provided on the website ‘naver’.

As used herein, the user terminal group includes at least one user terminal, and the recommendation content list generated based on the assessment information, which is assessed by the user terminals, is shared within the user terminal group.

The user terminal group may be a set of user terminals corresponding to users with a similar preference in terms of content. In such a user terminal group, content that is preferred by an arbitrary user within the user terminal group can be expected to be preferred by another user within the same user terminal group. Thus, the assessment information on content that is assessed by an arbitrary user within the user terminal group may be regarded as being the same as that assessed by another user within the same terminal group.

A process of searching for user terminals with a similar preference in terms of content includes allowing each user to generate profile information including preference information on content and searching for the user terminals with a similar preference in terms of content, based on the profile information. The user terminals with a similar preference in terms of content may be searched either by a web server or by comparing the profile information between the user terminals through communications therebetween.

The content distribution manager 110 includes an identification number generation unit 112 and an identification number distribution unit 114. The identification number generation unit 112 generates an identification number for each set of content. The identification number may be generated in any form as long as the identification number can identify each set of content.

For example, when content is classified into 10 sets of content, numbers from 1 to 10 can be distributed to the respective 10 sets of content, without overlapping, as identification numbers. In another example, the identification number may be a hash value generated using a hash function. The hash function is an arbitrary function that receives a predetermined value and transforms the predetermined value into a bitstream of a predetermined size. Any function that generates non-overlapping output values may be used as the hash function. These output values of the hash function may be assigned as the respective identification numbers of the sets of content.

The identification number distribution unit 114 distributes the generated identification numbers to the respective user terminals within the user terminal group. Distributing an identification number to each user terminal means that a set of content with the same identification number as the user terminal is distributed to the corresponding user terminal. Thus, the user terminal generates assessment information on the content included in the set of content that corresponds to the distributed identification number.

There are various ways to distribute the generated identification numbers to the respective user terminals within the user terminal group. For example, the identification number distribution unit 114 may randomly distribute the generated identification numbers to the respective user terminals within the user terminal group. Alternatively, an equal number of identification numbers can be distributed to each user terminal. In addition, the number of identification numbers distributed to each user terminal may vary, such as by distributing more identification numbers to a user terminal that more rapidly generates assessment information on the content based on, for example, previously received assessment information by the user terminals.

In another example, the identification number distribution unit 114 may distribute the identification numbers to the respective user terminals within the user terminal group using modular operation values. In this case, as shown in FIG. 1, the identification number distribution unit 114 includes a modular operation unit 116 and an identification number distribution unit 118.

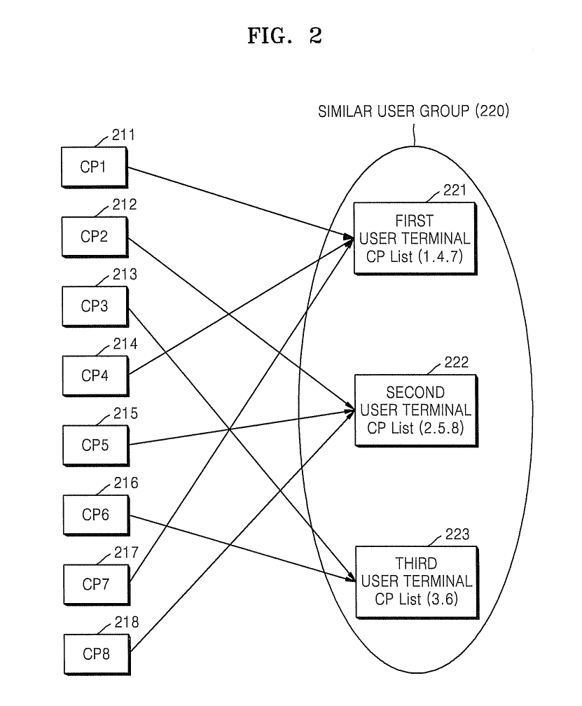

The modular operation unit 116 performs a modular operation on the generated identification numbers. The identification number distribution unit 118 distributes the identification numbers with the same result value of the modular operations to the user terminals within the user terminal group. The distribution of identification numbers using the modular operation will be described in detail later with reference to FIG. 2.

The assessment information collection unit 120 collects the assessment information on the content included in the set of content from the corresponding user terminals. In order to easily collect the assessment information from the user terminals, the assessment information collection unit 120 may include a metadata address transfer unit 122 and an assessment information reception unit 124.

The metadata address transfer unit 122 transfers address information of metadata for the content included in the set of content to user terminals that will assess the corresponding content. In order to assess the content, the entire content may be reproduced, or only metadata may be reproduced. In the latter case, in order for a user terminal to easily obtain the metadata for the corresponding content, the address information of the metadata is transferred to the corresponding user terminal.

A list of content to be assessed by user terminals may be displayed, along with the recommendation content list, directly on the user terminals or via a separate user interface, thereby inducing the user terminals to assess the corresponding content. In this case, the list of content to be accessed by the user terminals may include the address information of the metadata. The assessment information reception unit 124 receives the assessment information on the content that is obtained based on the metadata from the corresponding user terminals.

The recommendation content list generation unit 130 generates a recommendation content list based on the assessment information on the content. At least two user terminals may be used to assess the same content, thereby resulting in at least two assessments of the same content. The average of at least two assessments may be determined as the final assessment information on the corresponding content. Alternatively, an appropriate weight may be assigned to each user terminal so that the assessment information of a user terminal with a larger weight is reflected more.

The recommendation content list generation unit 130 may assign a higher recommendation rank to content with a higher assessment score, based on the assessment information on the content. Alternatively, the recommendation content list may be generated by compiling the assessment information on the content that is obtained by a conventional method, and the assessment information on the content obtained by the assessment information collection unit 120 according to aspects of the present invention.

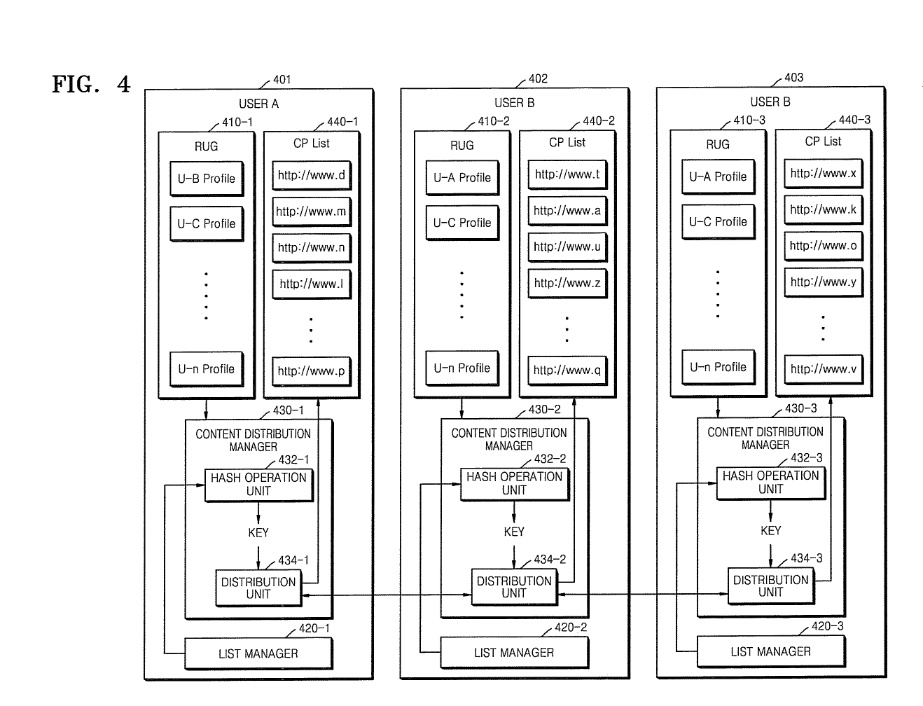

The recommendation content list generating apparatus 100 may further include a database (not shown) storing the recommendation content list so as to be shared by all the user terminals within the user terminal group. The recommendation content list generating apparatus 100 may be implemented on the Internet or in a user terminal. An embodiment of the recommendation content list generating apparatus 100 implemented in a user terminal will be described later with reference to FIG. 4.

FIG. 2 shows the identification number distribution unit 114 according to an embodiment of the present invention. In the example shown in FIG. 2, the content to be assessed is classified into 8 sets of content by content providers (CPs). Numbers from 1 to 8 are allocated to the respective sets of content as identification numbers. CP1, designated by reference numeral 211, is a set of content with an identification number of 1. CP2, designated by reference numeral 212, is a set of content with an identification number of 2. Similarly, CP8, designated by reference numeral 218, is a set of content with an identification number of 8.

A modular operation may be used to distribute the identification numbers to the respective sets of content. According to the modular operation, a remainder obtained as a result of dividing an input value by a predetermined value is output as a result value. As shown in FIG. 2, there are three user terminals within a similar user terminal group 220. In this case, a remainder obtained by dividing each of the identification numbers by 3 becomes the result value of the modular operation performed on each identification number.

When the modular operation is performed on the identification numbers, for the identification numbers of ‘1’, ‘4’, and ‘7’, the remainder obtained by dividing these identification numbers by ‘3’ are all ‘1’, so the result values of the modular operations is ‘1’. The remainder obtained by dividing the identification numbers of ‘2’, ‘5’, and ‘8’ by ‘3’ are all ‘2’, so the result values of the modular operations is ‘2’. The remainder obtained by dividing the identification numbers ‘3’ and ‘6’ by ‘3’ are all ‘0’, so the result values of the modular operations is ‘0’.

The sets of content with an identification number of ‘1’, ‘4’ and ‘7’ are allocated to a first user terminal 221. The first user terminal 221 generates the assessment information on the content included in the sets of content CP1, CP4 and CP7, which are respectively designated by 211, 214, and 217, and then transfers the assessment information to the recommendation content list generating apparatus 100.

The sets of content with an identification number ‘2’, ‘5’ and ‘8’ are allocated to a second user terminal 222. The second user terminal 222 generates the assessment information on the content included in the sets of content CP2, CP5 and CP8, which are respectively designated by 212, 215, and 218, and then transfers the assessment information to the recommendation content list generating apparatus 100.

Similarly, the sets of content with an identification number of ‘3’ and ‘6’ are assigned to a third user terminal 223. The third user terminal 223 generates the assessment information on the content included in the sets of content CP3 and CP6, which are respectively designated by reference numerals 213 and 216, and then transfers the assessment information to the recommendation content list generating apparatus 100.

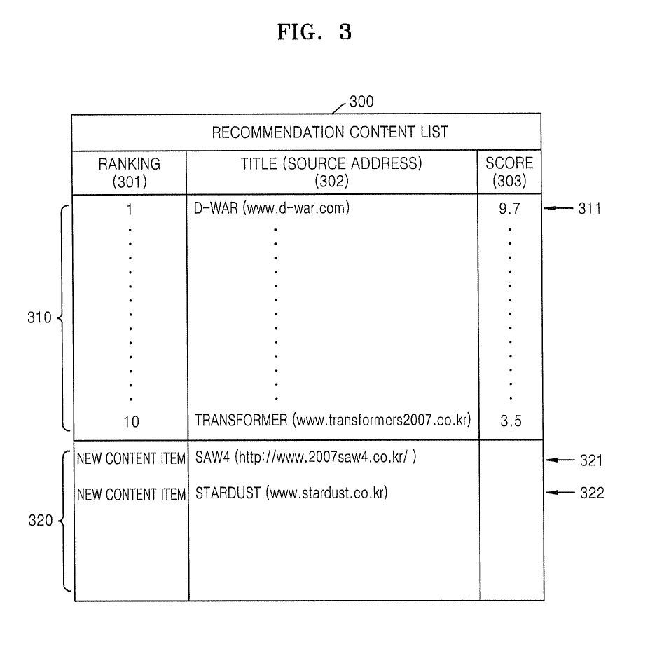

FIG. 3 shows an example of displaying a list of content to be assessed on a user terminal. A recommendation content list 300 may include a recommendation content item 310 and a new content item 320, as shown in FIG. 3. The new content item 320 includes a list of new content whose assessment information will be provided by user terminals. The list of new content may include entirely new content without any assessment information or content with insufficient assessment information and which requires additional assessment information. The recommendation content list 300 includes a ranking 301, a title (source address) 302, and a score 303 for the content included in the recommendation content item 310 and the new content items 320.

In the recommendation content item 310, the content is arranged in an ascending order of assessment scores based on the assessment information on the content received from the user terminals. D-war 311 is ranked as Top 1 with an assessment score of 9.7. As shown in FIG. 3, the content listed in the recommendation content item 310 is movie content. However, any type of content, for example, advertisement content, music content, and book content, can be presented in the recommendation content item 310.

In another embodiment, the recommendation content item 310 may be shared by the user terminals within a similar user terminal group with a similar preference in terms of content. In this case, the recommendation content item 310, which is identical for all of the user terminals, may be displayed on the user terminals within the similar user terminal group.

The new content item 320 includes content to be assessed by the user terminals to which the content is distributed by the content distribution manager 110. As shown in FIG. 3, “Saw 4” 321 and “Stardust” 322 are movie content to be assessed by the user terminals.

As described with reference to FIG. 1, the sets of content distributed to the respective user terminals by the content distribution manager 110 differ from one another. Thus, even for the user terminals within the similar user terminal group, the content to be assessed by the user terminals is different. In addition, the content in the new content item 320 included in the recommendation content list 300 is different.

FIG. 4 shows a recommendation content list generating apparatus according to another embodiment of the present invention that is implemented in a similar user terminal group 400. The similar user terminal group 400 includes a first user terminal 401, a second user terminal 402, and a third user terminal 403. The number of users in the similar user terminal group 400 is not limiting; the similar user terminal group 400 may have any number of user terminals. Since the first user terminal 401, the second user terminal 402, and the third user terminal 403 operate in the same manner, the operation of the first, second and third user terminals 401, 402 and 403 will be described only once with reference to the first user terminal 401.

A similar user terminal list 410-1 includes information on the similar user terminal group 400 to which the first user terminal 401 belongs. The information on the similar user terminal group 400 may be information on the user terminals within the similar user terminal group 400. The information on the user terminals within the similar user terminal group 400 may include profile information in which a preference in terms of content in each user terminal is analyzed.

A list manager 420-1 manages a list of content. The list manager 420-1 manages the list of content by classifying the content using content providers.

A content distribution manager 430-1 includes a hash operation unit 432-1 and a distribution unit 434-1. The content distribution manager 430-1 receives information on the user terminals in the similar user terminal group from the user terminal list 410-1 and receives from the list manager 420-1 content without assessment information and a list of content providers who provide the content without assessment information.

The content distribution manager 430-1 classifies the content without assessment information by content providers and distributes the content to the first user terminal 401, the second user terminal 402, and the third user terminal 403. The content distribution manager 430-1 may use a hash function in order to distribute the content without assessment information to the first user terminal 401, the second user terminal 402, and the third user terminal 403. The content distribution manager 430-1 generates an identification value for each content provider using the hash operation portion 432-1.

The content distribution manager 430-1 distributes some of the identification values to the first user terminal 401 through the distribution unit 434-1. Distributing some of the identification values to the first user terminal 401 includes distributing the content providers with those identification values to the first user terminal 401. Thus, the first user terminal 401 generates assessment information on the content without assessment information among the content provided by the content providers with the distributed identification numbers.

For example, distributing the identification values to the user terminals by the distribution portion 434-1, is performed by using a modular operation. The modular operation is performed on the identification values generated by the hash operation unit 432-1. Identification values with the same result of the modular operations may be assigned to the first user terminal 401. The modular operation has been described above in detail with reference to FIG. 2.

A content provider list 440-1 stores a list of content providers (CPs) that have the identification values distributed by the distribution portion 434-1 and that provide the content to be assessed by the first user terminal 401.

The first user terminal 401 receives metadata for the content without assessment information from among the content provided by the content providers stored in the content provider list 440-1. The first user terminal 401 displays the assigned content or the metadata for the assigned content to a first user who uses the first user terminal 401 in order to obtain assessment information, and transfers the obtained assessment information to the list manager 420-1.

The list manager 420-1 in the first user terminal receives, from the second and third user terminals 402 and 403, the assessment information on the content assigned to the second and third user terminals 402 and 403, and collects the received assessment information. A recommendation content list is generated based on the collected assessment information and stored in a predetermined space so as to be shared by the user terminals within the similar user terminal group.

A specific content provider may have the same identification number in each user terminal. For example, if a content provider named ‘daum’ has an identification number of 1 in the first user terminal 401, the identification number for the content provider ‘daum’ may be 1 in both the second and third user terminals 402 and 403. In addition, the distribution of an arbitrary content provider might not overlap between user terminals. For example, once a content provider named ‘daum’ has been distributed to the first user terminal 401, the content provider ‘daum’ would not be distributed to the second and third user terminals 402 and 403. The first user terminal 401 communicates with the second and third user terminals 402 and 403 in order for a specific content provider to have the same identification value in each user terminal and to be distributed so as not to overlap in the other user terminals.

However, unlike the embodiment in FIG. 4, a recommendation content list generating apparatus according to the present invention may be implemented in a server on the Internet, instead of in each user terminal. In this case, the recommendation content list generating apparatus in the Internet server acquires assessment information through communications with each user terminal and generates a recommendation content list. Here, communication between the user terminals is unnecessary, provided that the recommendation content list generating apparatus can communicate with each user terminal.

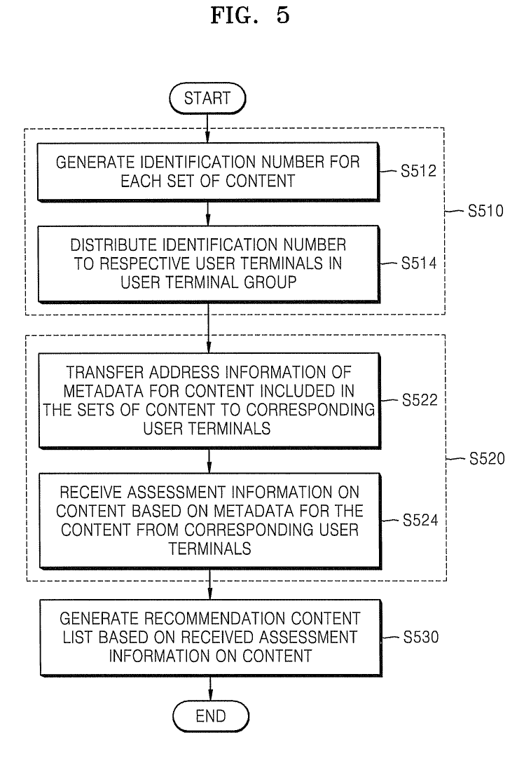

FIG. 5 is a flowchart of a recommendation content list generating procedure according to an embodiment of the present invention. In Operation S510, the sets of content classified according to a predetermined criterion are distributed to each user terminal within a user terminal group. The user terminal group may be a group of user terminals with a similar preference in terms of content. The sets of content classified according to a predetermined criterion may be the sets of content classified by content providers.

In Operation S512, an identification number for each set of content is generated. The identification number may be a hash value generated using a hash function. In Operation S514, the identification numbers generated in Operation S512 are respectively distributed to the user terminals within the user terminal group. Operation S514 can be performed by applying a modular operation on each generated identification numbers and distributing the identification numbers with the same result of the modular operations to a specific user terminal within the user terminal group, based on the results of the modular operations.

In Operation S520, assessment information on the content included in the sets of content is obtained from the corresponding user terminals. Operation S520 may include Operations S522 and S524. In Operation S522, address information of the metadata for the content included in the sets of content is transferred to the corresponding user terminals. In Operation S524, the assessment information on the content, which is obtained based on the metadata for the content, is received from the corresponding user terminals. In Operation S530, a recommendation content list is generated based on the received assessment information on the content.

As described above, according to aspects of the present invention, assessment information on content is obtained by selecting a similar user terminal group and appropriately assigning the content to be assessed to the user terminals within the similar user terminal group. Thus, more candidate content that can be ranked on a recommendation content list is obtained, and the recommendation content list can be rapidly generated.

Aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, optical data storage devices, and DVDs. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of generating a recommendation content list that is shared by user terminals in a user terminal group, the method comprising:
distributing sets of content that are classified according to a predetermined criterion to the user terminals within the user terminal group;
collecting assessment information from the corresponding user terminals on the content included in the sets of content; and
generating the recommendation content list based on the collected assessment information on the content.

2. The method of claim 1, wherein the collecting of the assessment information comprises:
transferring address information of metadata for the content included in the sets of content to the corresponding user terminals; and
receiving the assessment information on the content, which is obtained based on the metadata, from the corresponding user terminals.

3. The method of claim 1, wherein the user terminal group is a set of user terminals with a similar preference in terms of content.

4. The method of claim 1, wherein the sets of content that are classified according to the predetermined criterion are classified by content provider.

5. The method of claim 1, wherein the distributing of the sets of content to the user terminals comprises:
generating identification numbers for each set of content; and
distributing the generated identification numbers to the respective user terminals within the user terminal group.

6. The method of claim 5, wherein the identification numbers are hash values generated using a hash function.

7. The method of claim 5, wherein the distributing of the identification numbers to the respective user terminals comprises:
performing a modular operation on each of the identification numbers; and
distributing the identification numbers with the same modular operations results to a specific user terminal within the user terminal group, based on the results of the modular operation.

8. The method of claim 1, further comprising storing the recommendation content list.

9. An apparatus to generate a recommendation content list that is shared by user terminals within a user terminal group, the apparatus comprising:
a content distribution manager to distribute sets of content that are classified according to a predetermined criterion to the user terminals within the user terminal group;
an assessment information collection unit to collect assessment information on the content included in the sets of content from the corresponding user terminals; and
a recommendation content list generation unit to generate the recommendation content list based on the collected assessment information on the content.

10. The apparatus of claim 9, wherein the assessment information collection unit comprises:
a metadata address transfer unit to transfer address information of metadata for content included in the sets of content to the corresponding user terminals; and
an assessment information reception unit to receive the assessment information on the content, which is obtained based on the metadata, from the corresponding user terminals.

11. The apparatus of claim 9, wherein the user terminal group is a set of user terminals with a similar preference in terms of content.

12. The apparatus of claim 9, wherein the sets of content that are classified according to a predetermined criterion are the sets of content that are classified by content providers.

13. The apparatus of claim 9, wherein the content distribution manager comprises:
an identification number generation unit to generate identification numbers for the respective sets of content; and
an identification number distribution unit to distribute the identification numbers to the respective user terminals within the user terminal group.

14. The apparatus of claim 13, wherein the identification numbers are hash values generated using a hash function.

15. The apparatus of claim 13, wherein the identification number distribution unit comprises:
a modular operation unit to perform a modular operation on each of the generated identification numbers; and
an identification number distribution unit to distribute the identification numbers with the same modular operations results to a specific user terminal within the user terminal group, based on the results of the modular operations.

16. The apparatus of claim 9, further comprising a database to store the recommendation content list.

17. A computer readable recording medium having embodied thereon a program to execute the method of claim 1.

18. A system to generate a recommendation content list, comprising:
a plurality of user terminals classified into groups of user terminals based on content preferences, to provide assessment information on new content transmitted to the user terminals; and
a recommendation content list generating apparatus to distribute sets of content to the groups of user terminals based on predetermined criteria, to receive the assessment information on the content contained in the sets of content from the user terminals, and to generate the recommendation content list based on the received assessment information.

19. The system of claim 18, wherein:
each of the user terminals generates a profile including content preferences for the user terminal and transmits the profiles to the recommendation content list generating apparatus; and
the recommendation content list generating apparatus searches for other user terminals having similar content preferences, based on the generated profiles, and classifies the user terminal into one of the groups of user terminals based on the result of the search.

20. The system of claim 18, wherein the plurality of user terminals communicate with the recommendation content list generating apparatus via the internet.

21. The system of claim 18, wherein the recommendation content list comprises:
recommendation content items arranged in ascending order based on the assessment information received from the user terminals; and
new content items to be distributed to the groups of user terminals;
wherein each of the recommendation content items and each of the new content items includes a ranking, a title, and an assessment score.

22. The system of claim 21, wherein the new content items include content items having no corresponding assessment information and content items that require additional assessment information.

23. The system of claim 21, wherein the recommendation content list generating apparatus shares each recommendation content item with all user terminals in one of the groups of user terminals, based on the content preferences of the group of user terminals.

24. A user terminal to provide assessment information and to generate a recommendation content list, the user terminal comprising:
a similar user terminal list including information on a group of user terminals including the user terminal and having similar content preferences;
a list manager to manage a list of content by classifying the content based on a predetermined criterion;
a content distribution manager to distribute content to user terminals in the group of user terminals based on the predetermined criterion; and
a list manager to receive assessment information from the group of user terminals including the user terminal and to generate a recommendation content list based on the received assessment information.

25. The user terminal of claim 24, wherein the predetermined criterion is a content provider.

26. The user terminal of claim 25, further comprising:
a content provider list to store information on content providers that provide the content;
wherein the content distribution manager generates identification values for each of the content providers, assigns each of the user terminals one or more of the identification values, and transmits content provided by each of the content providers to the user terminal having a corresponding identification value.

27. The user terminal of claim 26, wherein the content provider list comprises:
a hash operation unit to generate the identification values using a hash function; and
a distribution unit to distribute the content to the user terminals in the group of user terminals based on the identification values.

28. The user terminal of claim 24 wherein:
the content distribution manager distributes the content to the user terminals by distributing metadata about the content to the user terminals that allows a user of the user terminal to access the content.
